(19) United States
(12) Patent Application Publication
(10) Pub. No.: US 2026/0145163 A1
(43) Pub. Date: May 28, 2026

(54) CATALYST FOR REFORMING METHANE-CONTAINING GAS, MANUFACTURE METHOD OF THE SAME, AND REFORMING METHOD OF METHANE-CONTAINING GAS USING THE SAME

(71) Applicant: HEESUNG CATALYSTS CORPORATION, Siheung-si (KR)

(72) Inventors: Ho-Dong KIM, Namyangju-si (KR); Dong Kun KANG, Siheung-si (KR); Ki-Jung KIM, Siheung-si (KR); Yoo Cheol KIM, Ansan-si (KR); Semyung YANG, Siheung-si (KR); Jeongwan CHE, Seoul (KR)

(21) Appl. No.: 19/392,499

(22) Filed: Nov. 18, 2025

(30) Foreign Application Priority Data
Nov. 28, 2024 (KR) 10-2024-0174105

(51) Int. Cl. B01J 23/83; B01J 21/02; B01J 35/61; B01J 35/63; B01J 37/00; B01J 37/08; B01J 37/16; C01B 3/40

(52) U.S. Cl. CPC B01J 23/83; B01J 21/02; B01J 35/612; B01J 35/613; B01J 35/638; B01J 37/0045; B01J 37/08; B01J 37/16; C01B 3/40; C01B 2203/0227; C01B 2203/1058; C01B 2203/1241

(57) ABSTRACT

Disclosed are a catalyst for reforming methane-containing gas, a method for manufacturing the same, and a method for reforming methane-containing gas using the same. The catalyst for reforming methane-containing gas includes a porous carrier and an active metal supported within the porous carrier; wherein the active metal includes nickel; the porous carrier includes calcium aluminate (CaAl₂O₄), a modified inorganic binder, and water; the modified inorganic binder includes an aluminum compound and an alkaline earth metal compound, and a tensile strength of the porous carrier measured by a compressive strength tester is greater than or equal to 300 N

### CROSS-REFERENCE TO RELATED APPLICATION

This application claims priority to and the benefit of Korean Patent Application No. 10-2024-0174105 filed with the Korean Intellectual Property Office on Nov. 28, 2024, the entire contents of which are incorporated herein by reference.

### BACKGROUND OF THE INVENTION

### (a) Field of the Invention

The present disclosure relates to a catalyst for reforming methane-containing gas, a manufacturing method of the same, and a reforming method of methane-containing gas using the same.

### (b) Description of the Related Art

In general, natural gas, by-product gas from steelmaking, or biogas contains methane as a primary component, and a reaction of producing hydrogen from the methane-containing gases corresponds to an endothermic reaction. Accordingly, the reforming reaction of the methane-containing gases is carried out at a high temperature, wherein an excessive amount of steam is injected thereinto to reduce a coke formation rate that inevitably occurs during the reaction.

A currently commercialized reaction (Reaction Scheme 1 below) of methane and steam is performed under the presence of a catalyst within a temperature range of 800° C. to 1,000° C., while injecting them at a steam/methane ratio (in general, a steam/carbon (or S/C) ratio) of 1.0 to 3.0, to produce a synthesis gas of hydrogen and carbon monoxide.

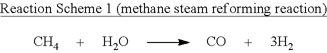

In addition, the carbon monoxide produced according to the reaction of methane and steam is introduced into a water gas shift reaction (Reaction Scheme 2 below) to additionally produce hydrogen, which contributes to increasing a hydrogen yield.

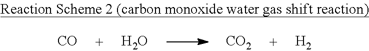

In this regard, a theoretical conversion reaction scheme from natural gas or biogas containing methane as a primary component to hydrogen is as follows.

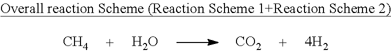

Hereinafter, the ‘conversion reaction from natural gas or biogas containing methane as a primary component to hydrogen’ is referred to as ‘reformation of methane-containing gas,’ which uses a catalyst for reforming the methane-containing gas, which is in general an active metal (e.g., nickel) supported on a porous carrier in the form of an oxide.

However, the active metal in the catalyst has a disadvantage of being gradually aggregated and sintered at a high temperature to have a larger particle size and thereby, accelerating a deactivation speed of the catalyst. In addition, there is another problem of cracking/destroying the catalyst itself, if the coke formed during the reforming reaction is deposited inside pores of the porous carrier.

### SUMMARY OF THE INVENTION

An embodiment provides a catalyst for reforming methane-containing gas having excellent resistance to coke deposition while suppressing catalyst sintering.

An embodiment provides a catalyst for reforming a methane-containing gas, which includes a porous carrier and an active metal supported within the porous carrier; wherein the active metal includes nickel; the porous carrier comprises calcium aluminate (CaAl₂O₄), a modified inorganic binder, and water; and the modified inorganic binder includes an aluminum compound and an alkaline earth metal compound; wherein a compressive strength of the porous carrier measured by a compressive strength tester is greater than or equal to 300 N.

Another embodiment provides a method for manufacturing the catalyst for reforming the methane-containing gas.

Another embodiment provides a method for reforming a methane-containing gas using the catalyst for reforming the methane-containing gas.

According to an embodiment, by using a catalyst for reforming methane-containing gas having excellent resistance to coke deposition while suppressing catalyst sintering, not only can deactivation of the catalyst be suppressed after the reforming reaction of methane-containing gas, but also the mechanical strength of the catalyst can be maintained.

### BRIEF DESCRIPTION OF THE DRAWINGS

FIG. 1A is a photograph taken immediately after the molding and curing of the molded product in Example 1.

FIG. 1B is a photograph of the catalyst manufactured in Example 1.

FIG. 2 shows the methane conversion rate according to the reaction time of the catalyst when the steam/methane ratio is 2.5 in Evaluation Example 2.

FIG. 3 shows the methane conversion rate according to the reaction time of the catalyst when the steam/methane ratio is 1.25 in Evaluation Example 2.

FIG. 4 shows the activity decrease rate according to the reaction time of the catalyst when the steam/methane ratio is 1.25 in Evaluation Example 2.

FIG. 5 shows the catalytic strength according to the reaction time of the catalyst when the steam/methane ratio is 1.25 in Evaluation Example 2.

### DETAILED DESCRIPTION OF THE EMBODIMENTS

### Definition of Terms

Throughout this specification, when a part “includes” a certain element, this means that it may further include other elements rather than excluding other elements, unless specifically stated to the contrary.

As used throughout this specification, the term “˜ing step” or “step of ˜ing” does not mean “step for ˜ing.”

As used herein, when a definition is not otherwise provided, the particle diameter may refer to an average particle diameter. In addition, the particle diameter may refer to an average particle diameter (D₅₀), which means the diameter of particles having a cumulative volume of 50 vol % in the particle size distribution. The average particle diameter (D₅₀) may be measured by a method well known to those skilled in the art, for example, by a particle size analyzer, or by a transmission electron microscope image, or a scanning electron microscope image. Alternatively, a dynamic light-scattering measurement device is used to perform a data analysis, and the number of particles is counted for each particle size range. From this, the average particle diameter (D₅₀) value may be easily obtained through a calculation. Alternatively, it can be measured using a laser diffraction method. When measuring by the laser diffraction method, more specifically, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

Based on the above definitions, embodiments of the present invention will be described in detail. However, these embodiments are exemplary, the present disclosure is not limited thereto and the present disclosure is defined by the scope of claims.

### (Catalyst for Reforming Methane-Containing Gas)

An embodiment provides a catalyst for reforming methane-containing gas including a porous carrier and an active metal supported within the porous carrier; wherein the active metal includes nickel; the porous carrier includes calcium aluminate (CaAl₂O₄), a modified inorganic binder, and water; the modified inorganic binder includes an aluminum compound and an alkaline earth metal compound, and a compressive strength of the porous carrier measured by a compressive strength tester is greater than or equal to 300 N.

An embodiment relates to a catalyst for reforming methane-containing gas, which is applied under conditions of high temperature and excess steam to increase methane conversion rate and hydrogen production rate.

A catalyst for reforming methane-containing gas according to an embodiment may exhibit excellent resistance to coke deposition while suppressing catalyst sintering. Accordingly, when a catalyst for reforming a methane-containing gas of one embodiment is used, not only is deactivation of the catalyst suppressed even after the reforming reaction of the methane-containing gas, but the mechanical strength of the catalyst may be maintained.

Hereinafter, a catalyst for reforming methane-containing gas according to an embodiment is described in detail.

### [Porous Carrier]

The porous carrier includes calcium aluminate (CaAl₂O₄), a modified inorganic binder, and water.

### Calcium Aluminate

The porous carrier basically uses calcium aluminate (CaAl₂O₄), a basic substance capable of suppressing coke formation.

### Modified Inorganic Binder

In the porous carrier, an aluminum compound capable of direct bonding with the active metal while mediating bonding between different calcium aluminates (CaAl₂O₄) is used. Accordingly, the aluminum compound may function as a binder and a carrier, and as a result, the dispersibility of nickel may be improved when nickel is supported on the porous carrier.

Additionally, an alkaline earth metal compound was also introduced as a binder into the porous carrier. The alkaline earth metal compound may suppress acidity of the acidic aluminum compound, and ultimately form a carrier having a structure in which basic properties are maximized.

As will be described later, the aluminum compound and the alkaline earth metal compound are each in a form that has been modified from the ‘inorganic binder’ as the initial input raw material, and therefore, they are referred to as ‘a modified inorganic binder.’

However, organic binders are not used because they hinder strength increase.

The aluminum compound may include gamma alumina, delta alumina, eta alumina, theta alumina, cerium aluminate, calcium aluminate, calcium-magnesium aluminate, nickel aluminate, or a combination thereof.

The alkaline earth metal compound may include magnesium oxide, magnesium aluminate, calcium-magnesium aluminate, or a combination thereof.

A weight ratio of the calcium aluminate (CaAl₂O₄) and the modified inorganic binder may be 100:1 to 100:30, 100:5 to 100:20, or 100:5 to 100:15. In this range, the synergistic effect of the calcium aluminate (CaAl₂O₄) and the modified inorganic binder can be exhibited.

### Water

The water included in the porous carrier can not only drastically increase the mechanical strength compared to the case where it is not included, but also maintain a high strength even after the catalytic reaction.

Based on the total amount of 100 wt % of the porous carrier, the water may be included in an amount of 1 to 10 wt %, 2 to 10 wt %, or 4 to 6 wt %. Within this range, the mechanical strength of the porous carrier may be significantly improved.

### Properties of Porous Carriers

A compressive strength of the porous carrier measured by a compressive strength tester may be greater than or equal to 300 N, greater than or equal to 310 N, or greater than or equal to 320 N. The upper limit is not particularly limited, but may be less than or equal to 500 N, less than or equal to 450 N, or less than or equal to 430 N.

A BET specific surface area of the porous carrier may be 1 to 90 m²/g, 1 to 50 m²/g, 1 to 30 m²/g, or 1 to 25 m²/g.

A pore volume of the porous carrier may be 12.0 to 30.0 cm³/g, 12.0 to 25.0 cm³/g, or 12.0 to 20.0 cm³/g.

In this way, the porous carrier may compensate the low internal surface area of the calcium aluminate but rather increase the pore volume and also, exhibit high mechanical properties.

### [Active Metal]

The active metal includes nickel as a main active metal, wherein the nickel may be included in an amount of 1 to 30 wt %, 5 to 20 wt %, or 10 to 15 wt % based on 100 wt % of a total amount of the catalyst.

If the nickel is included in an excessive amount, the nickel may not be introduced into the porous carrier but accumulated on the carrier surface, resulting in low nickel dispersibility, which may reduce durability of the catalyst.

On the other hand, because the calcium aluminate has a low internal surface area, if supported by a high content of the nickel, the nickel metal may be partially agglomerated during the reforming reaction, thereby gradually deteriorating a methane conversion rate of the catalyst.

In order to prevent this, there may be a design of introducing cerium in a bi-metallic form bonded to the nickel as an auxiliary active metal capable of continuously maintaining the nickel dispersibility to suppress the activity deterioration during the reaction.

The nickel/the cerium may have a weight ratio of 1 to 10, 3 to 9, or 4 to 8 and desirably, a weight ratio of 5 or so. Within the ranges, the nickel and the cerium may express a synergistic effect.

### (Method for Manufacturing Catalyst for Reforming Methane-Containing Gas)

An embodiment provides a method for manufacturing a catalyst for reforming methane-containing gas, which includes compressing a wet mixture of calcium aluminate (CaAl₂O₄) and an inorganic binder to manufacture a molded product; curing, drying, and firing the molded product to obtain a porous carrier; supporting an active metal precursor on the porous carrier; drying and firing the active metal precursor supported on the porous carrier, and then reducing it under a hydrogen atmosphere to obtain a final catalyst, wherein the active metal includes nickel; and the inorganic binder includes aluminum hydroxide and alkaline earth metal hydroxide.

A manufacturing method according to an embodiment includes wet mixing an inorganic binder including aluminum hydroxide and alkaline earth metal hydroxide with calcium aluminate (CaAl₂O₄), which is a basic material, and compression molding, followed by post-treatment with a moisture curing and calcination process to manufacture a high-strength carrier, and then manufacturing a catalyst in the form of supporting an active metal.

This may be a method for manufacturing a catalyst for reforming methane-containing gas of the aforementioned embodiment.

Hereinafter, descriptions overlapping with the above will be omitted, and a manufacturing method according to an embodiment will be described in detail.

### [Manufacturing Process of Carrier]

### Pre-Treatment Process

As the calcium aluminate (CaAl₂O₄), a calcium aluminate (CaAl₂O₄) powder having an average particle diameter (D50) of 100 to 500 μm, 200 to 500 μm, or 300 to 500 μm, which is heat-treated at a temperature range of 500 to 1,200° C., 600 to 1,000° C., or 700 to 900° C., may be used.

If the calcium aluminate (CaAl₂O₄) has too small an average particle diameter, cohesion between particles may be weakened in a compression molding process described below, which may deteriorate strength of a molded product. In contrast, if the calcium aluminate (CaAl₂O₄) has too large an average particle diameter, the molded product may have a smaller pore volume but higher density and thus not function as a carrier.

The inorganic binder includes aluminum hydroxide and alkaline earth metal hydroxide.

In addition to aluminum hydroxide, the material used as the inorganic binder may include aluminum hydroxide, boehmite, pseudoboehmite, aluminum stearate, alumina, magnesium hydroxide, magnesium oxide, magnesium silicate, silicate, silica, silica-alumina, titania, zirconia, and the like, but is not limited thereto.

For example, the inorganic binder may be an aluminum-containing binder, which may have good bonding strength with the calcium aluminate and function as a carrier in addition to a binder, and an alkali-aluminum hybrid binder, which may exhibit basic properties.

The calcium aluminate (CaAl₂O₄) and the inorganic binder may have a weight ratio of 100:5 to 100:30 or 100:5 to 100:15. Within the ranges, the calcium aluminate (CaAl₂O₄) and the inorganic binder may express a synergistic effect.

The inorganic binder may have an average particle diameter (D₅₀) ranging from 100 to 500 μm, 200 to 500 μm, or 300 to 500 μm, similar to the calcium aluminate (CaAl₂O₄).

If the inorganic binder has a different average particle diameter (D₅₀) from that of the calcium aluminate (CaAl₂O₄), layer separation may occur when mixing them, which may cause a problem of locally reducing uniformity within the molded product during the compression molding.

### Wet Mixing Process

The wet mixture of the calcium aluminate (CaAl₂O₄) and the inorganic binder may include 1 to 10 parts by weight, 2 to 10 parts by weight, or 4 to 6 parts by weight of water, based on 100 parts by weight of the total amount of the calcium aluminate (CaAl₂O₄) and the inorganic binder.

If the water is insufficient during this process, boning strength between powders may become very weak during the compression molding described later, which makes it difficult to secure strength of the carrier. In the contrary, if the water is excessive, the powders may be agglomerated, not only making continuous production impossible when fed into a compression molding machine but also resulting in unsuitable strength and shape of a final molded product.

### Compression Molding Process

The wet mixture of the calcium aluminate (CaAl₂O₄) and the inorganic binder may be compressed at a pressure of 400 kg/cm² to 800 kg/cm².

During this process, the molded product may be manufactured to have a desired shape, density, strength, and the like. The shape of the molded product may be various types such as a cylinder type, a hole type, etc. and have various sizes without particular limitations, and the density of the molded product is determined depending on the molding pressure, which makes it possible to manufacture a carrier with desired characteristics as a result of numerous experiments.

### Curing Process

The molded product may be cured for 1 hour to 12 hours or 4 hours to 8 hours.

In this process, the strength of the molded product may be increased, but if the curing time is insufficient, because the curing ends before increasing the strength of the molded product, no increase in the strength may be expected. On the contrary, if the curing time is excessively spent, the surface area and the pore volume of the carrier itself may be decreased, thereby reducing a maximum supporting amount of the active metal.

### Drying and Firing Process

The cured molded product may be dried within a temperature range of 80° C. to 120° C. or 90° C. to 110° C. and fired within a temperature range of 400° C. to 1,200° C., 600° C. to 1,100° C., or 800° C. to 1,000° C.

This process may increase bonding strength between each material in the cured molded product. In addition, the binder in the cured molded product, which has not yet been modified, may be modified into an oxide through the firing process.

If the firing temperature is excessively low, aluminum hydroxide in the cured molded product may not be completely modified into an oxide, and an organic material in the cured molded product may not be removed. Meanwhile, if the firing temperature is excessively high, the aluminum hydroxide in the cured molded product may be changed to alpha alumina, which has a greatly reduced specific surface area, making it not function as a carrier.

When this process is performed, the finally treated alumina from the aluminum hydroxide may have a crystal phase such as gamma, delta, eta, or theta phase which may appear within the heat treatment temperature range.

### [Supporting Process]

The active metal precursor may be supported on the porous carrier obtained through the curing, drying, and firing processes of the molded product using a spray drying method.

The nickel precursor used here may be one of nickel nitrate hydrate, nickel chloride hydrate, nickel acetate hydrate, and nickel sulfate hydrate can be used, and the cerium precursor used here may be one of cerium nitrate hydrate, cerium chloride hydrate, cerium acetate hydrate, cerium sulfate hydrate, and cerium oxalate hydrate.

For example, it can be prepared and used as a carrier solution by mixing sequentially or simultaneously compounds having the same anionic form.

The active metal precursor may be manufactured by dissolving the active metal precursor in an amount equal to the pore volume of the porous carrier in a solvent such as deionized water or dihydric alcohol (ethanol, ethylene glycol, etc.) and supporting it on the carrier using a dipping method or spray coating method. For example, the active metal precursor may be manufactured using a spray drying method.

In a state where the active metal is supported on the porous carrier, drying may be performed at a temperature range of 80 to 180° C., 90 to 150° C., or 100 to 130° C., and firing may be performed at a temperature range of 400 to 1,000° C., 500 to 900° C., or 500 to 800° C.

In this process, water and anions derived from the active metal precursor may be removed, and the active metal precursor (e.g., nickel compound, cerium compound, etc.) may be converted into an active metal oxide. The firing may be performed at a temperature within an appropriate range as is common knowledge, and thus no further detailed explanation will be provided. However, in order to prevent deformation of the active metal in the catalyst during the reforming reaction of the methane-containing gas, the firing may be performed at a temperature higher than the reforming reaction temperature of the methane-containing gas.

After the drying and firing, reduction may be performed at a temperature range of 400 to 1,000° C., 500 to 900° C., or 500 to 800° C.

In this process, the active metal oxide may be rapidly reduced. However, if the temperature is too low during the reduction process, the active metal oxide may not be completely reduced, and if the temperature is too high, agglomeration and sintering of the active metal particles may occur, resulting in a decrease in active sites.

The reduction process may be performed in a step manner, for example, by heating to 600° C. in an air or nitrogen atmosphere and then injecting hydrogen gas.

If two or more types of active metal species are included in the catalyst, when exposed to hydrogen gas at high temperature as in the reduction method, the active metal species may be instantly manufactured into an alloy form.

However, when Reducing by Gradually Increasing the Temperature from Room temperature in a hydrogen atmosphere, it is difficult to form an alloy form because each type of metal is reduced according to its own oxygen desorption temperature.

### (Method for Reforming Methane-Containing Gas Using the Same)

Another embodiment provides a method for reforming a methane-containing gas using the catalyst for reforming the methane-containing gas according to the embodiment described above.

Since this uses the catalyst for reforming the methane-containing gas described above, not only is deactivation of the catalyst suppressed even after the reforming reaction of the methane-containing gas, but the mechanical strength of the catalyst may also be maintained. Accordingly, a high hydrogen conversion rate may be achieved.

Hereinafter, descriptions overlapping with the above will be omitted, and a method for reforming methane-containing gas according to an embodiment will be described in detail.

The methane-containing gas may be a methane-containing gas mixed with steam/natural gas or biogas (commonly referred to as the S/C ratio) in a volume ratio of 1.25 to 2.5.

The reforming reaction of the methane-containing gas may produce hydrogen by introducing the catalyst into a reactor and then subjecting a mixture of steam and methane-containing gas to a gas phase reaction.

The reforming reaction of the methane-containing gas may be performed under conditions of a gas space velocity of 1,000 to 30,000 h⁻¹.

However, the above is only an example, and as the gas space velocity increases, the amount of hydrogen produced increases proportionally, so the optimal value may be arbitrarily adjusted according to the reactor volume and catalyst amount, and therefore, it is not limited to a specific value within the above range.

The reforming reaction of the methane-containing gas may be performed within a temperature range of 700° C. to 900° C.

If the reforming reaction temperature of the methane-containing gas is too low, the reforming reaction may insufficiently proceed, obtaining a very small amount of hydrogen. On the contrary, If the reforming reaction temperature of the methane-containing gas is too high, the active metal of the catalyst introduced into the reactor may exhibit agglomeration and sintering phenomena and side reactions such as coke formation, cracking reaction, and the like, which may cause a problem with catalyst durability.

The reactor is not particularly limited, but a fixed-bed catalytic reactor inside which a catalyst is filled may be used. Additionally, since the dehydrogenation reaction is an endothermic reaction, it is important that the reactor is always kept adiabatic. The reforming reaction process of the present invention may proceed while maintaining reaction conditions such as a reaction temperature, a pressure, and a gas space velocity within each appropriate range.

Hereinafter, the present invention will be described with reference to Examples, but the following Examples are intended to illustrate the present invention, and the scope of the present invention is not limited to these Examples.

### Example 1

### (1) Manufacturing of Porous Carrier

Calcium aluminate having an average particle size (D₅₀) of 450 μm was prepared as a carrier raw material by heat treatment at 800° C.

As a first inorganic binder, aluminum hydroxide was prepared to have an average particle diameter (D₅₀) of 450 μm.

The prepared calcium aluminate as a carrier raw material and the aluminum hydroxide as a first inorganic binder were mixed with deionized water by using a mixer.

Herein, according to Table 1 below, a ratio of carrier raw material/total binder was adjusted to 20, and the deionized water also was adjusted to 5 wt % based on 100 wt % of the total mixture.

Subsequently, the mixture was molded into a cylindrical shape with a size of 5 mm by using a compression molding machine at a compression pressure of 600 kg/cm² or less, and the molded product was placed on an inner mesh of a curing machine filled with water at the bottom and then, after closing its upper lid, allowed to stand at 80° C. for 8 hours. The molded product, after completing the moisture curing, was dried at 100° C. in a drier for 12 hours and then, heat-treated at 900° C. for 6 hours, obtaining a porous carrier.

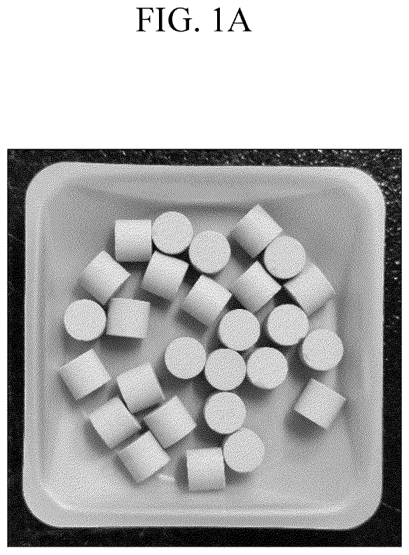

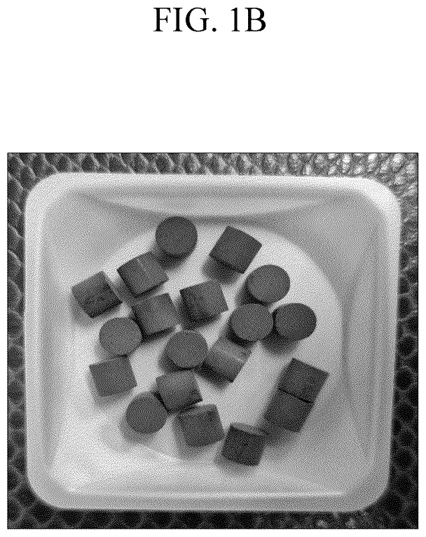

FIG. 1A is a photograph taken immediately after molding and curing of the molded product in Example 1, and FIG. 1B is a photograph of the catalyst manufactured in Example 1.

### (2) Manufacturing of Catalyst

After dissolving nickel nitrate (Ni(NO₃)₂·6H₂O) and cerium nitrate (Ce(NO₃)₃·6H₂O) in deionized water, the porous carrier was impregnated therein by using a spray drying method. After the impregnation, the porous carrier was aged for about 1 hour, so that the metal solution was sufficiently distributed into the carrier, and then, dried at 120° C. for 12 hours to remove moisture inside a catalyst and heat-treated at 700° C. for 6 hours under an air atmosphere to fix the metal. Subsequently, the heat-treated catalyst was heated to 600° C. under the air atmosphere, purged with nitrogen for 5 minutes, and then, rapidly reduced while flowing hydrogen gas, manufacturing the catalyst.

Accordingly, the manufactured catalyst contained 10.0 wt % of nickel and 2.0 wt % of cerium based on 100 wt % of a total amount of the catalyst, and in addition, the nickel-cerium was uniformly distributed inside the carrier.

### Example 2

### (1) Manufacturing of Porous Carrier

Calcium aluminate having an average particle size (D₅₀) of 450 μm was prepared as a carrier raw material by a heat treatment at 800° C.

Aluminum hydroxide as a first inorganic binder and magnesium hydroxide as a second inorganic binder were prepared to have each average particle diameter (D₅₀) of 450 μm.

The prepared calcium aluminate as carrier raw material, the aluminum hydroxide as a first inorganic binder, and the magnesium hydroxide as a second inorganic binder were mixed with deionized water at a high speed by using a mixer.

Herein, as shown in Table 1, the carrier raw material/the total binder were mixed to have a ratio of 20, the first inorganic binder/the second inorganic binder were mixed to have a ratio of 15, and the deionized water was adjusted to 5 wt % based on 100 wt % of the total mixture.

Subsequently, the mixture was molded into a cylindrical shape with a size of 5 mm by adjusting the molding pressure to 600 kg/cm² or less with the molding machine, placed on the inner mesh of the curing machine filled with water at the bottom, and then, after closing its upper lid, allowed to stand at 80° C. for 8 hours.

The molded product, after completing with the moisture curing, was dried at 100° C. in the drier for 12 hours and then, heat-treated at 900° C. for 6 hours, obtaining a porous carrier.

### (2) Manufacturing of Catalyst

A catalyst was manufactured in the same manner as in Example 1 except that the porous carrier was used.

### Example 3

A catalyst was manufactured in the same manner as in Example 2 except that the cerium, an auxiliary metal, was not used as shown in Table 2.

### Example 4

A catalyst was manufactured in the same manner as in Example 2 except that the ratio of carrier raw material/total binder was changed to 5, as shown in Table 1.

### Example 5

A catalyst was manufactured in the same manner as in Example 2 except that the ratio of carrier raw material/total binder was changed to 30, as shown in Table 1.

### Example 6

A catalyst was manufactured in the same manner as in Example 2 except that the ratio of first inorganic binder/second inorganic binder was changed to 5, as shown in Table 1.

### Comparative Example 1

A catalyst was manufactured in the same manner as in Example 2 except that the curing process was not performed in molding the carrier.

### Comparative Example 2

A porous carrier and a catalyst were manufactured in the same manner as in Example 1 except that the inorganic binders were not used at all in molding the carrier.

### Comparative Example 3

A porous carrier and a catalyst were manufactured in the same manner as in Example 2 except that silica powder was used as the first inorganic binder in molding the carrier.

### Comparative Example 4

A porous carrier was manufactured in the same manner as in Example 2 except that PVA (polyvinyl alcohol), an organic binder, was used in molding the carrier. However, while this porous carrier was cured, the carrier failed in maintaining a shape, which resulting in manufacturing no catalyst.

### Comparative Example 5

A porous carrier and a catalyst were manufactured in the same manner as in Example 1 except that alumina powder was used instead of the calcium aluminate as the carrier raw material.

### Comparative Example 6

A porous carrier and a catalyst were manufactured in the same manner as in Example 1 except that alumina powder was used instead of the calcium aluminate as the carrier raw material, and the curing process was not performed.

The porous carrier compositions of the examples and the comparative examples are shown in Table 1, and the active metal compositions of the examples and the comparative examples are shown in Table 2.

TABLE 1

| | Preparation of carrier | | | | | |
|---|---|---|---|---|---|---|
| | | | | | | First |
| | | | | | | inorganic |
| | Carrier | First | Second | | carrier raw | binder/second |
| | raw | inorganic | inorganic | Organic | material/total | inorganic |
| | material | binder | binder | binder | binder ratio | binder ratio |
| Example 1 | CaAl₂O₄ | Al(OH)₃ | — | — | 20 | — |
| Example 2 | CaAl₂O₄ | Al(OH)₃ | Mg(OH)₂ | — | 20 | 15 |
| Example 3 | CaAl₂O₄ | Al(OH)₃ | Mg(OH)₂ | — | 20 | 15 |
| Example 4 | CaAl₂O₄ | Al(OH)₃ | Mg(OH)₂ | — | 5 | 15 |
| Example 5 | CaAl₂O₄ | Al(OH)₃ | Mg(OH)₂ | — | 30 | 15 |
| Example 6 | CaAl₂O₄ | Al(OH)₃ | Mg(OH)₂ | — | 20 | 5 |
| Comparative Example 1 | CaAl₂O₄ | Al(OH)₃ | Mg(OH)₂ | — | 20 | 15 |
| Comparative Example 2 | CaAl₂O₄ | — | — | — | — | — |
| Comparative Example 3 | CaAl₂O₄ | SiO₂ | Mg(OH)₂ | — | 20 | 15 |
| Comparative Example 4 | CaAl₂O₄ | Al(OH)₃ | Mg(OH)₂ | PVA 10% | 30 | 15 |
| Comparative Example 5 | Al₂O₃ | Al(OH)₃ | — | — | 20 | — |
| Comparative Example 6 | Al₂O₃ | Al(OH)₃ | — | — | 20 | — |

TABLE 2

| | Active metal characteristics in catalyst | | |
|---|---|---|---|
| | Ni content | Ce content | Ni dispersibility in |
| | (wt %) | (wt %) | catalyst (%) |
| Example 1 | 10 | 2 | 22 |
| Example 2 | 10 | 2 | 24 |
| Example 3 | 10 | — | 17 |
| Example 4 | 10 | 2 | 20 |
| Example 5 | 10 | 2 | 28 |
| Example 6 | 10 | 2 | 18 |
| Comparative Example 1 | 10 | 2 | 22 |
| Comparative Example 2 | 10 | 2 | 10 |
| Comparative Example 3 | 10 | 2 | 20 |
| Comparative Example 4 | — | — | — |
| Comparative Example 5 | 10 | 2 | 26 |
| Comparative Example 6 | 10 | 2 | 27 |

### Evaluation Example 1: Physical Properties Before and After Obtaining a Porous Carrier after Compression Molding

The examples and the comparative examples were evaluated with respect to properties after the compression molding in preparing the porous carriers and properties after post-treatment of the final products in the following methods, and the results are shown in Table 3.

### (1) Physical Properties (Compressive Strength) Before and After Obtaining Porous Carriers After Compression Molding

### Compressive Strength Measuring Equipment: Compressive Strength Tester

The catalysts were measured with respect to compressive strength by using a compressive strength tester (Pharmatron hardness tester MT-50). Each catalyst sample was placed on a jig of the compressive strength tester to measure compressive strength in a transverse direction. The jig of the compressive strength tester was set at a moving speed of 2 mm/sec to calculate maximum instantaneous stress when each catalyst sample was destroyed.

### (2) Porous Carrier Properties (Specific Surface Area and Pore Volume)

### Specific Surface Area/Pore Volume Measurement Equipment: BET N₂ Physisorption

Nitrogen adsorption isotherms were measured at −196° C. on a volume adsorption analyzer, Micromeritics Tristar 3000. Before measuring adsorption, all the samples were degassed at 300° C. in a degassing station. A Brunauer-Emmett-Teller (BET) equation was used to calculate a specific surface area from adsorption data obtained at P/P₀ between 0.05 and 0.2. A total volume of micropores and mesopores was calculated from an amount of nitrogen adsorbed at P/P₀=0.95, assuming that adsorption on the external surface to adsorption in the pores was negligible.

TABLE 3

| | Physical | | | | |
|---|---|---|---|---|---|
| | properties before | | | | |
| | obtaining porous | | | | |
| | carrier after | | | | |
| | compression | | | | |
| | molding | | Porous carrier properties | | |
| | Compressive | Post- | Compressive | Specific | Pore |
| | strength | treatment | strength | surface area | volume |
| | (N) | process | (N) | (m²/g) | (cm³/g) |
| Example 1 | 60 | curing-firing | 430 | 13 | 17.0 |
| Example 2 | 56 | curing-firing | 403 | 16 | 17.4 |
| Example 3 | 56 | curing-firing | 403 | 16 | 17.4 |
| Example 4 | 53 | curing-firing | 420 | 8 | 12.0 |
| Example 5 | 56 | curing-firing | 328 | 21 | 18.1 |
| Example 6 | 60 | curing-firing | 424 | 14 | 17.1 |
| Comparative Example 1 | 56 | firing | 91 | 20 | 14.1 |
| Comparative Example 2 | 55 | curing-firing | 453 | 5 | 11.4 |
| Comparative Example 3 | 52 | curing-firing | 246 | 16 | 14.8 |
| Comparative Example 4 | 69 | curing-firing | shape | — | — |
| | | | destruction | | |
| Comparative Example 5 | 83 | curing-firing | 166 | 93 | 11.6 |
| Comparative Example 6 | 83 | firing | 161 | 96 | 11.5 |

Referring to Tables 2 and 3, the examples and the comparative examples manufactured through the same process were compared as follows.

Example 1 using an inorganic binder, compared with Comparative Example 2 using no inorganic binder at all, was expected to exhibit an increased specific surface area and an increased pore volume, thereby increasing catalyst efficiency.

Example 2 using aluminum hydroxide as the first inorganic binder, compared to Comparative Example 3 using silica, was confirmed to exhibit an increased pore volume and significantly improved mechanical properties (compressive strength).

Example 2 using no organic binder exhibited that the porous carrier maintained a shape, but Comparative Example 4 using the organic binder exhibited that the porous carrier did not maintained the shape but collapsed.

The examples and the comparative examples with the same compositions are compared as follows.

Example 2, which underwent the curing and firing process, compared to Comparative Example 1, in which the curing process was omitted, was confirmed to exhibit an increased pore volume and significantly improved mechanical properties (compressive strength).

The examples and the comparative examples, which used calcium aluminate or not, were compared as follows.

Comparative Examples 5 and 6 using alumina instead of the calcium aluminate, compared to Example 1 using the calcium aluminate, were confirmed to exhibit so significantly increased specific surface area as to deteriorate mechanical properties (compressive strength).

### Evaluation Example 2: Reforming Reaction of Methane-Containing Gas

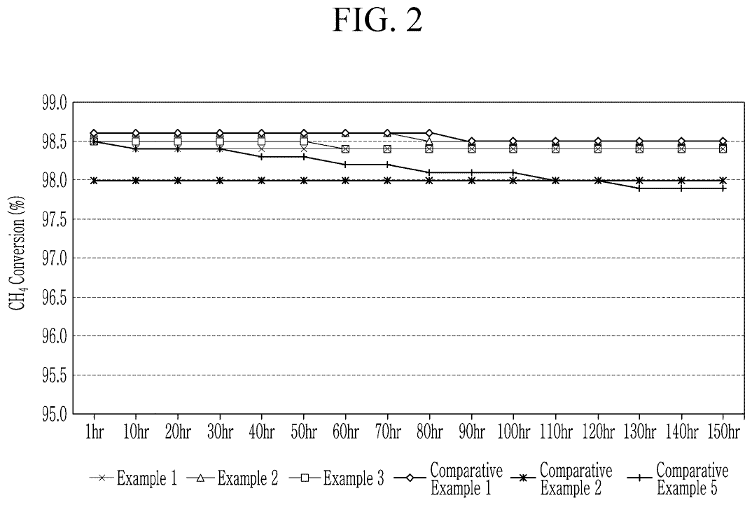

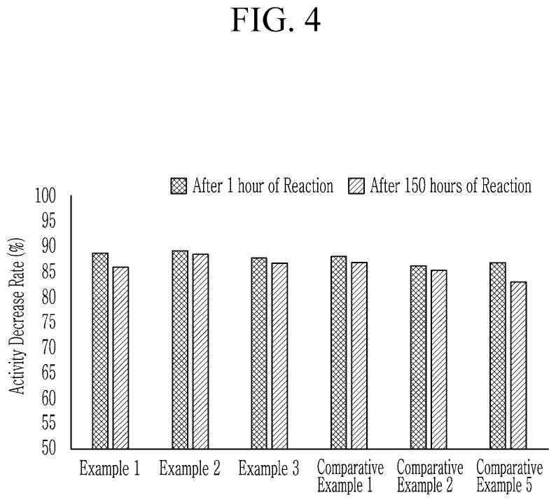

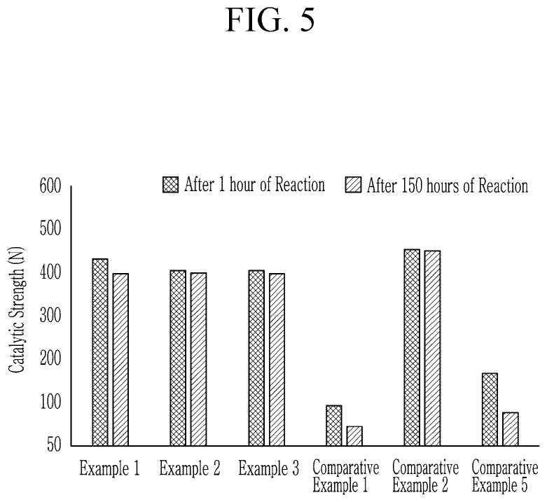

The catalysts according to the examples and the comparative examples were respectively used to perform a reforming reaction of methane-containing gas at a reaction temperature of 800° C., a space speed (SV) of 2,000/hr, and a steam/methane volume ratio of 2.5 or 1.25, and the evaluation results for steam/methane volume ratio conditions are shown in Tables 4 and 5 and diagramed in FIGS. 2 to 5.
(1) Catalytic Reaction: The Specific Catalytic Reaction is as Follows.

The catalysts were evaluated with respect to activity by using a mixed gas of methane and hydrogen and a fixed-bed reaction system as a reactor. Each of the catalysts was charged at 1.57 g in the tubular reactor and then, reduced at 800° C. for 1 hour by constantly flowing hydrogen gas at 30 cc/min to remove oxygen species on the catalyst surface before the reaction. Subsequently, after constantly maintaining the reactor at the reaction temperature of 800° C., the reactor was continuously supplied with a mixed gas of methane and hydrogen in a volume ratio of 1:1 as raw materials used for the reaction at a constant hourly space velocity of 2000 h⁻¹.

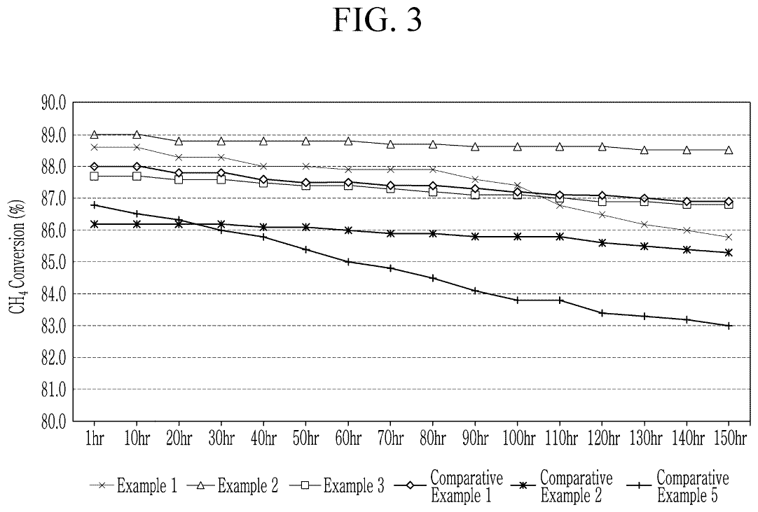

In addition, in order to suppress coke formation during the catalytic reaction, steam/methane were injected therewith at a ratio of 2.5 (Table 4 and FIG. 2) or 1.25 (Table 5 and FIGS. 3 to 5). Herein, a reaction pressure was constantly maintained at 1.0 atm by using a pressure regulator. A material produced after the reaction was transferred to GC (Gas Chromatography) through an injection line and then, subjected to quantitative analysis through FID (flame ionization detector) and TCD (thermal conductivity detector; thermal conductivity detector).
(2) Methane conversion rate by steam/methane volume ratio and reaction time: The conversion rate of methane for the reactants was calculated using Equation 1, and the activities of the catalysts were compared.

$$Methan conversion rate ( \% ) = [ number of moles of methane before reaction - number of moles of methane after reaction ] / [ number of moles of methane before reaction ] \times 100 \qquad [ Equation 1 ]$$

(3) Coke deposition amount by steam/methane volume ratio: The amount of coke deposited on the catalyst after 150 hours of reaction was measured.
(4) Catalytic strength and strength change rate after 150 hours of reaction by steam/methane volume ratio: The compressive strength of the catalyst after 150 hours of reaction was measured by a compressive strength tester, and the change rate compared to the compressive strength of the catalyst before reaction was calculated.

TABLE 4

| | Reforming reaction of methane-containing gas | |
|---|---|---|
| | S/C = 2.5 | |
| | Methane conversion | Methane conversion |
| | rate after 1 h | rate after 150 h |
| | reaction (%) | reaction (%) |
| Example 1 | 98.5 | 98.4 |
| Example 2 | 98.6 | 98.5 |
| Example 3 | 98.5 | 98.4 |
| Example 4 | 98.4 | 98.4 |
| Example 5 | 98.6 | 98.5 |
| Example 6 | 98.6 | 98.5 |
| Comparative Example 1 | 98.6 | 98.5 |
| Comparative Example 2 | 98.0 | 98.0 |
| Comparative Example 3 | 98.4 | 98.4 |
| Comparative Example 4 | — | — |
| Comparative Example 5 | 98.5 | 97.9 |
| Comparative Example 6 | 98.4 | 97.8 |

TABLE 5

| | Reforming reaction of methane-containing gas | | | | |
|---|---|---|---|---|---|
| | S/C = 1.25 | | | | |
| | Methane | Methane | Coke | | |
| | conversion | conversion | deposition | Catalytic | |
| | rate | rate after | amount after | strength | Strength |
| | after 1 h | 150 h | 150 h | after 150 h | change |
| | reaction | reaction | reaction | reaction | rate |
| | (%) | (%) | (%) | (N) | (%) |
| Example 1 | 88.6 | 85.8 | 2.4 | 397 | 7.7 |
| Example 2 | 89.0 | 88.5 | 1.4 | 398 | 1.2 |
| Example 3 | 87.7 | 86.8 | 1.5 | 397 | 1.5 |
| Example 4 | 86.9 | 86.0 | 1.5 | 410 | 2.4 |
| Example 5 | 89.3 | 87.5 | 1.8 | 301 | 8.2 |
| Example 6 | 88.6 | 87.1 | 2.0 | 405 | 4.5 |
| Comparative | 88.0 | 86.9 | 1.9 | 43 | 52.7 |
| Example 1 | | | | | |
| Comparative | 86.2 | 85.3 | 1.5 | 449 | 0.9 |
| Example 2 | | | | | |
| Comparative | 87.5 | 86.6 | 1.8 | 201 | 18.3 |
| Example 3 | | | | | |
| Comparative | — | — | — | — | — |
| Example 4 | | | | | |
| Comparative | 86.8 | 83.0 | 2.9 | 76 | 54.2 |
| Example 5 | | | | | |
| Comparative | 86.5 | 81.8 | 3.2 | 74 | 54.0 |
| Example 6 | | | | | |

Referring to Tables 4 and 5 and FIGS. 2 to 5, the examples and the comparatives examples all exhibited a high methane conversion rate of greater than or equal to about 98% even after 150 hours' reaction at a high steam/methane ratio of 2.5 but when the steam/methane ratio was lowered to 1.25, very different catalytic strength as well as an activity deterioration rate after the reaction were found.

Examples 1 to 6, in which the porous carriers were manufactured according to a ratio of carrier raw material/total binder, had mostly high activity and coke resistance and a low strength change rate at the same time, compared to Comparative Examples 1 to 6.

Specifically, each of the examples was separately examined from the comparative examples as follows.

First, the catalysts of Example 2 and Comparative Example 1 were manufactured by preparing their porous carriers in different manufacturing methods depending on the presence or absence of moisture curing.

Compared to Comparative Example 1 into which the curing process was not introduced, Example 2 into which the curing process was introduced exhibited that compressive strength of the porous carrier rapidly increased. Furthermore, after the activity evaluation, Comparative Example 1, into which the curing process was not introduced, was confirmed that the catalyst exhibited a decrease in compressive strength by about 50%, but Example 2, into which the curing process was introduced, was confirmed that the catalyst exhibited almost no strength compressive change.

In Example 2 and Comparative Example 2, the catalysts were manufactured by using different methods depending on whether or not an inorganic binder was used.

Comparative Example 2, compared to that of Example 2, was confirmed that the catalyst exhibited a similar activity decrease rate but a low methane conversion rate, because nickel metal was not smoothly dispersed due to a significantly small specific surface area of the final porous carrier.

In Example 1 and Comparative Examples 5 and 6, the catalysts of were manufactured by using different methods according to different carrier raw materials.

Example 1 exhibited about 2.5 times higher compressive strength after the moisture curing than Comparative Example 5.

When the catalysts manufactured by using each carrier were subjected to reaction evaluation, Example 1 using a basic carrier exhibited all superior results in an activity decline rate, a coke formation rate, and a catalytic strength reduction rate after the reaction to Comparative Examples 5 and 6 using alumina, an acidic carrier.

This shows that the moisture curing of carriers was more effective in the basic carrier with a spinel structure than one with a pure alumina structure and also, that the carrier with the basic structure, unlike the alumina carrier rich in acid sites, were advantageous in catalytic reaction and catalyst durability.

In Examples 1 and 2, the catalysts were manufactured by using different methods according to combinations of inorganic binders.

The two catalysts exhibited no performance change even during the long-term reactions at a high steam ratio of S/C=2.5, which is a relatively mild reaction condition.

However, at a low steam ratio of S/C=1.25, which is a harsh condition, Example 2 exhibited a lower activity decline rate and coke deposition amount after 150 hours' reaction than Example 1. This shows that compared to Example 1 using alumina alone as an inorganic binder, Example 2 using alumina surface-reformed with magnesium, a basic material, exhibited that side reactions such as methane cracking were suppressed by acid sites of the alumina itself, resultantly reducing the coke formation rate and thereby suppressing the performance deterioration.

In Examples 2 and 3, the catalysts were manufactured by using different methods depending on whether or not cerium, an auxiliary metal, was added.

Compared to the catalyst of Example 3 to which the cerium was not added, the catalyst of Example 2 to which the cerium was added exhibited that nickel dispersibility increased by 50%, which indicates superior initial reaction activity.

In short, the catalyst for reforming methane-containing gas according to some embodiments represented by Examples 1 to 6 was not only suppressed from the catalyst sintering phenomenon but also exhibited excellent resistance to coke deposition.

Accordingly, when the catalyst for reforming methane-containing gas according to some embodiments was used, the catalyst was not only suppressed from the deactivation even after the reforming reaction of the methane-containing gas but also still maintained mechanical strength.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A catalyst for reforming methane-containing gas, comprising
a porous carrier and an active metal supported within the porous carrier;
wherein the active metal comprises
nickel;
the porous carrier comprises
calcium aluminate (CaAl₂O₄),
a modified inorganic binder, and
water;
the modified inorganic binder comprises
an aluminum compound and
an alkaline-earth metal compound, and
a compressive strength of the porous carrier measured by a compressive strength tester is greater than or equal to 300 N.

2. The catalyst for reforming methane-containing gas of claim 1, wherein
based on 100 wt % of a total amount of the porous carrier,
the water is included in an amount of 1 to 10 wt %.

3. The catalyst for reforming methane-containing gas of claim 1, wherein
a weight ratio of the calcium aluminate (CaAl₂O₄) and modified inorganic binder is
100:1 to 100:30.

4. The catalyst for reforming methane-containing gas of claim 1, wherein
the aluminum compound comprises
gamma alumina, delta alumina, eta alumina, theta alumina, cerium aluminate, calcium aluminate, calcium magnesium aluminate, nickel aluminate, or a combination thereof, and
the alkaline-earth metal compound comprises
magnesium oxide, magnesium aluminate, calcium magnesium aluminate, or a combination thereof;

5. The catalyst for reforming methane-containing gas of claim 1, wherein
a BET specific surface area of the porous carrier is 1 to 90 m²/g.

6. The catalyst for reforming methane-containing gas of claim 1, wherein
a pore volume of the porous carrier is 12.0 to 30.0 cm³/g.

7. The catalyst for reforming methane-containing gas of claim 1, wherein
based on 100 wt % of a total amount of the catalyst,
the nickel is included in an amount of 1 to 30 wt %.

8. The catalyst for reforming methane-containing gas of claim 1, wherein
the active metal further comprises cerium.

9. The catalyst for reforming methane-containing gas of claim 8, wherein
a weight ratio of the nickel/cerium is 1 to 10.

10. A method for manufacturing a catalyst for reforming methane-containing gas, comprising
compressing a wet mixture of calcium aluminate (CaAl₂O₄) and an inorganic binder to manufacture a molded product;
curing, drying, and firing the molded product to obtain a porous carrier;
supporting an active metal precursor on the porous carrier;
drying and firing the active metal precursor supported on the porous carrier, and then reducing it under a hydrogen atmosphere to obtain a final catalyst, wherein the active metal comprises
nickel; and
the inorganic binder comprises
aluminum hydroxide and
alkaline earth metal hydroxide.

11. The method of claim 10, wherein
the calcium aluminate (CaAl₂O₄) is a calcium aluminate (CaAl₂O₄) powder having an average particle diameter (D₅₀) of 100 to 500 μm and heat-treated at a temperature range of 500 to 1,200° C.

12. The method of claim 10, wherein
an average particle diameter (D₅₀) of the inorganic binder is 100 to 500 μm.

13. The method of claim 10, wherein
the wet mixture of the calcium aluminate (CaAl₂O₄) and inorganic binder comprises water in an amount of 1 to 10 parts by weight
based on 100 parts by weight of the total amount of the calcium aluminate (CaAl2O4) and the inorganic binder.

14. The method of claim 10, wherein
The wet mixture of the above calcium aluminate (CaAl₂O₄) and the inorganic binder is compressed at a pressure of 400 to 800 kg/cm².

15. The method of claim 10, wherein
the curing of the molded product is performed for 1 to 12 hours.

16. The method of claim 10, wherein
the cured molded product is dried at a temperature range of 80 to 120° C. and fired at a temperature range of 400 to 1,200° C.

17. The method of claim 10, wherein
the active metal is supported on the porous carrier using a spray drying method.

18. The method of claim 10, wherein
in a state where the active metal is supported on the porous carrier, drying is performed at a temperature range of 80 to 180° C. and firing is performed at a temperature range of 400 to 1,000° C.

19. The method of claim 10, wherein
after the drying and firing, reduction is performed at a temperature range of 400 to 1,000° C.

20. A method for reforming methane-containing gas, using a catalyst for reforming methane-containing gas according to claim 1.
